(19) United States
(12) Patent Application Publication
(10) Pub. No.: US 2010/0165352 A1
(43) Pub. Date: Jul. 1, 2010

(54) ADIABATIC TAPERED COMPOSITE WAVEGUIDE FOR ATHERMALIZATION

(75) Inventor: Sergey Frolov, Murray Hill, NJ (US)

Correspondence Address: MAYER & WILLIAMS PC, 251 NORTH AVENUE WEST, 2ND FLOOR, WESTFIELD, NJ, 07090, US

(73) Assignee: CYOPTICS, INC., BREINIGSVILLE, PA (US)

(21) Appl. No.: 12/607,892

(22) Filed: Oct. 28, 2009

Related U.S. Application Data
(63) Continuation-in-part of application No. 11/522,853, filed on Sep. 18, 2006, now abandoned.

(51) Int. Cl. G01B 9/02; G02B 6/10; G02B 6/26

(52) U.S. Cl. 356/477; 385/129; 385/43; 264/1.24

(57) ABSTRACT

A planar waveguide circuit includes a silica-based planar optical waveguide circuit having a lower cladding, a core and an upper cladding. At least one input waveguide and one output waveguide are each coupled to the optical waveguide circuit. At least one tapered waveguide section is located in the waveguide circuit, which has an upper cladding segment that tapers down to at least the core to define a tapered recess. A filler material having a negative thermo-optic coefficient fills the tapered recess so that the optical waveguide circuit has an optical characteristic with a reduced temperature dependence.

### STATEMENT OF RELATED APPLICATIONS

This is a continuation-in-part of U.S. patent application Ser. No. 11/522,853, filed Sep. 18, 2006, entitled “Tapered Composite Waveguide For Athermalization”, which is incorporated by reference in its entirety herein.

### FIELD OF THE INVENTION

The present invention relates to the field of integrated optics and particularly to the production of wavelength filtering devices whose essential optical characteristics do not depend on fluctuations in ambient temperature.

### BACKGROUND OF THE INVENTION

Integrated optical waveguide circuits combine miniaturized waveguides and optical devices into a functional optical system incorporated onto a planar substrate. These planar lightguide circuits (PLCs) can incorporate a multitude of devices many of which depend on filtering, or the ability to select and perform specific operations upon individual channels of a dense-wavelength-division-multiplexed (DWDM) optical system. Such devices, even when providing good performance at constant temperature, often deteriorate rapidly when subjected to thermal variations such as fluctuations in ambient temperature. The root cause is the sensitivity of an optical path length s=NL of guide length L to temperature T, where N is the effective refractive index of the waveguide mode in question. Optical path length variations of this kind give rise to thermally induced spectral shifts of the filter spectrum. The effect is monitored by the coefficient ds/dT which, per unit length of waveguide, takes the form

(1/L)ds/dT=dN/dT+Nα, (1)

in which α is the linear expansion coefficient along the waveguide length. In PLC geometry, α is therefore equal to the linear expansion coefficient of the substrate. The dependence of ds/dT upon α enters Eq. (1) implicitly via the thermo-optic coefficient dN/dT as well as explicitly via Nα. In conventional silica-on-silicon PLC guides the numerical value of Eq. (1) is about 1.0×10⁻⁵ per degree Celsius. For a transmission peak in a passband filter centered at about 1550 nm, this value translates to shift of about 0.8 nm (or equivalently about 100 GHz) when temperature changes between 0 and 80° C. This shift corresponds to one spacing between typical DWDM channels and is therefore completely unacceptable.

Different solutions have been proposed to remedy temperature sensitivity of a PLC-based filter. One group of solutions utilizes mechanical means of compensating for the wavelength shift in the filter response; for example see J. B. D. Soole, M. Schlax, C. Narayanan and R. Pafchek, Electronics Letters v. 39, no. 16, p. 1182 (2003). These solutions, however, are typically bulky and often not compatible with optical integration. In another approach, specially-designed compensating grooves normal to a waveguide length are filled with resin; see for example U.S. Pat. No. 6,304,687. However, this method typically suffers from excess radiation loss in the groove region. In the third group of solutions, a hybrid waveguide is manufactured for which the athermal condition

ds/dT=L[dN/dT+Nα]=0 (2)

is achieved by biasing dN/dT to negative values, and thereby compensating the thermal expansion of the substrate uniformly throughout the waveguide circuit. This is achieved by covering and encapsulating the PLC waveguide cores with overclads composed of polymer materials possessing highly negative values of dN_{polymer}/dT; see for example, Y. Kokubun, N. Funato and M. Takizawa, IEEE Photonics Technology Letters v. 5, p. 1297 (1993), E. Kang, W. Kim, D. Kim, and B. Bae, IEEE Photonics Technology Letters v. 16, p. 2625 (2004), or U.S. Pat. No. 6,421,472. This solution, while it offers distinct advantages over the two previous ones, is often not manufacturable or compatible with other PLC elements. This is largely due to the polymer upper cladding, which limits processing conditions in wafer manufacturing, limits design options in waveguide optimization, hinders device reliability and complicates chip attachment procedures during packaging.

### SUMMARY OF THE INVENTION

The present invention discloses a method of PLC filter athermalization, which combines the advantages of the two latter approaches. In a tapered composite waveguide circuit only a small portion of a PLC circuit is made hybrid, i.e. composed of silica-based core material and another material with negative thermo-optic coefficient. The region between the regular PLC and hybrid PLC sections is adiabatically tapered, so that there is no optical loss between the two sections. The thermo-optic coefficient of the hybrid waveguide is designed in such a way as to be equal and opposite in sign to the ds/dT coefficient of the regular waveguide. Thus the thermally induced spectral shift of the filter built on this principle can be made negligibly small.

In one particular embodiment of the invention, a planar waveguide circuit is provided that includes a silica-based planar optical waveguide circuit having a lower cladding, a core and an upper cladding. At least one input waveguide and one output waveguide are each coupled to the optical waveguide circuit. At least one adiabatic tapered waveguide section is located in the waveguide circuit, which has an upper cladding segment that tapers down to at least the core to define a tapered recess. A filler material having a negative thermo-optic coefficient fills the tapered recess so that the optical waveguide circuit has an optical characteristic with a reduced temperature dependence.

### BRIEF DESCRIPTION OF THE DRAWINGS

FIGS. 1(a)-1(d) show cross sections of a composite planar waveguide used for filter athermalization in accordance with various embodiments of the invention.

FIG. 2 shows the manufacturing steps of a composite planar waveguide circuit.

FIG. 3. shows a schematic example of a regular Mach-Zehnder interferometer (A) and a Mach-Zehnder interferometer

FIG. 4 is graph showing the fraction of the optical mode confined in the upper cladding versus core height.

FIG. 5 is a graph showing the thermo-optic coefficient dN/dT of the composite section of the slab waveguide. (dN′/dT=10 ppm/K; dN″/dT=−100 ppm/K)

FIG. 6 shows an AWG using tapered sections in the array portion (A), first slab portion (B), and first and second slab portion (C) for achieving athermalization.

FIG. 7 shows a single stage Mach-Zehnder interferometer filter with an athermal tapered section.

FIG. 8 shows a single stage etalon filter based on a ring resonator with an athermal tapered section.

FIG. 9 shows a waveguide Bragg grating filter with an athermal tapered section.

### DETAILED DESCRIPTION AND EMBODIMENTS OF THE INVENTION

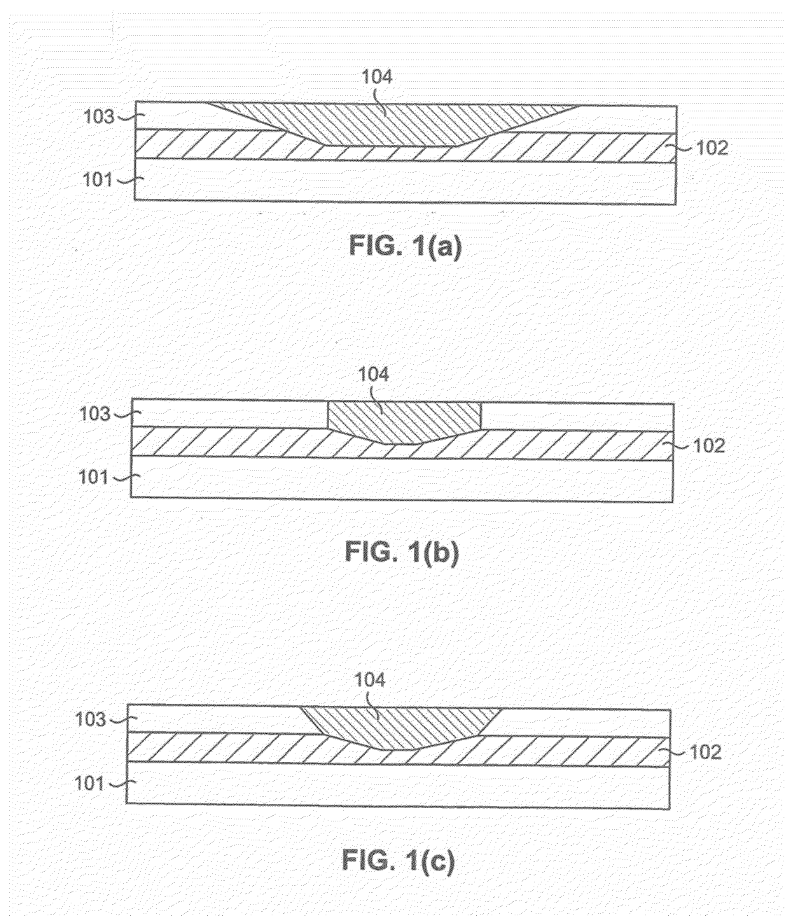

FIGS. 1(a)-1(d) show schematic drawings of various embodiments of a composite waveguide structure constructed in accordance with the present invention. The waveguide structure includes a lower cladding 101, waveguide core 102, upper cladding 103 and filler material 104. The filler material fills the tapered region on top of the upper cladding and the waveguide core, which could either be tapered or untapered i.e. its height could be smaller or unchanged. Various configurations of the tapered region (as shown by the corresponding configuration of the filler material 104) are shown in FIGS. 1(a)-1(d).

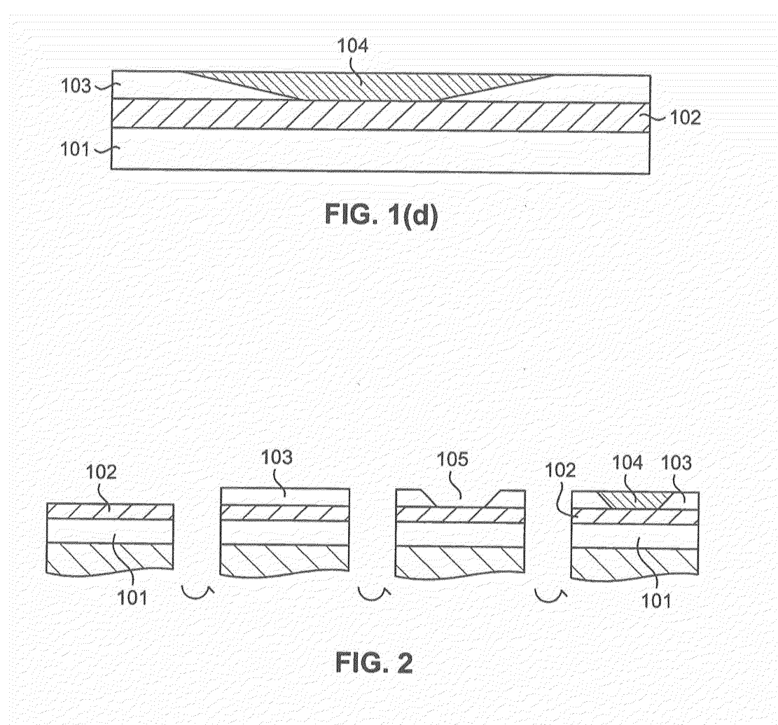

FIG. 2 illustrates the manufacturing sequence of a composite planar waveguide circuit of the type depicted in FIG. 1. The process begins the deposition of the lower cladding 101 and core 102 films onto a substrate (e.g. a silicon wafer), and then is followed by waveguide core patterning. The patterned core is subsequently overcoated with the upper cladding 103, which is then tapered by graded etching using, for instance, a gray scale mask. Finally, the tapered region 105 is filled with the material 104 having a negative thermo-optic coefficient. This could be accomplished by first depositing a thin filler film and then patterning it around the tapered regions 105. Optionally, the tapered region 105 could be protected from exposure to the environment (such as moisture) by overcoating it with thin metal film or sealing it with a hermetic cap.

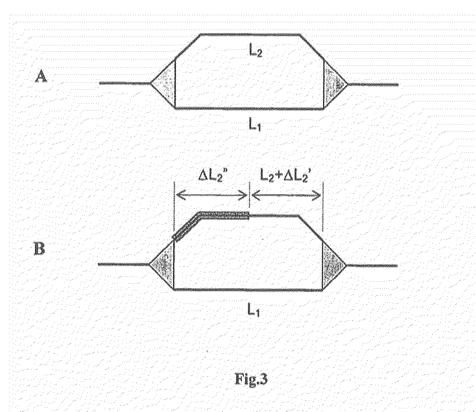

An optical filter is often characterized by a particular free spectrum range (FSR), which in turn is given by a characteristic waveguide length L and an effective (refractive) index N determined by the PLC design (e.g. L is the ring waveguide length in an etalon filter or the length difference between waveguide arms in interferometric filters, as for example shown in FIG. 3.A):

$$F S R = \frac{c}{NL} \qquad ( 3 )$$

in which c is the velocity of light. The dependence of N (and in some cases L) on temperature usually determines the temperature sensitivity of the filter. In order to compensate it, a composite waveguide structure may be introduced which, in addition to regular waveguides with modified length L+ΔL′, includes a hybrid section with a characteristic length ΔL″ and an effective index N″. An example is shown in FIG. 3B, where the upper arm of the Mach-Zehnder interferometer contains a composite waveguide with length ΔL₂″. In order to keep the same FSR it follows that the following condition has to be satisfied at some temperature within the operating temperature range:

ΔL′N′+ΔL″N″=0 (4)

where N′ is the effective index in the modified portion of the regular waveguide structure. In general N and N′ could be different depending on the exact location of the waveguide inside the filter circuit.

In addition, the athermal condition follows from Eq. (2) as

L(dN/dT)+ΔL′(dN′/dT)+ΔL″(dN″/dT)=0. (5)

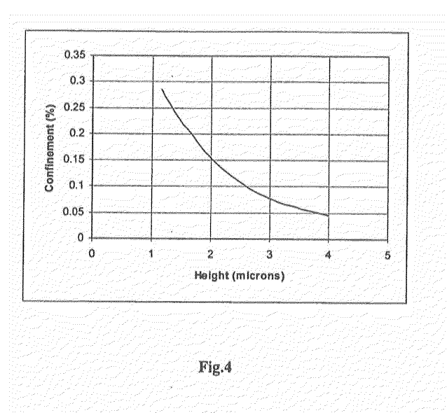

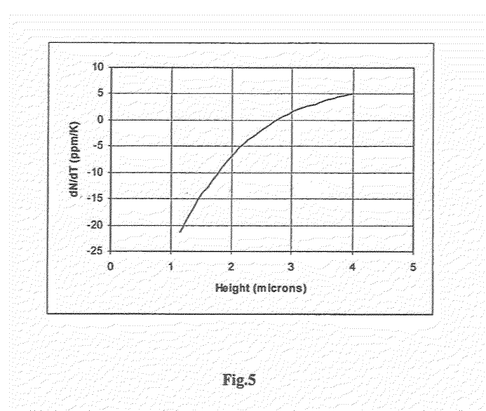

Here we have assumed a negligible contribution from the thermal expansion of the substrate (an approximation that is usually valid to better than 10% for PLCs on a silicon platform) but the equations are readily embellished to include substrate expansivity if required. There is an infinite number of solutions to Equations 4 and 5, the most obvious one being ΔL′=−L, ΔL″=L, N′≈N″≈N, dN″/dT=0. The implementation of this solution requires accurate index matching of the filler material to that of the upper cladding and waveguide mode design in the tapered region, in which dN″/dT=0. The latter can be easily accomplished by properly choosing the modal confinement factor in the upper cladding (or filler) region. FIG. 4 shows an example in which the filler confinement factor is adjusted for the slab mode versus the slab height with core index contrast of 1.5%. Using this result, one can choose appropriately the correct waveguide dimension i.e. that for which dN/dT=0—shown in the FIG. 5 example to correspond to a slab height of 2.8 microns.

In some embodiments the athermal condition may be satisfied by using a tapered region 105 that is adiabatic. The use of an adiabatic tapered region 105 ensures that the light traveling therein is always guided throughout the waveguide structure and that any scattering losses are eliminated. The adiabatic tapered region 105 is formed by providing adiabatic transitions between the various interfaces of the device with which the region 105 is in contact. An adiabatic transition is achieved by changing the structure and/or the refractive index of the tapered region 105 in a sufficiently slow manner so the light is not scattered from its mode when it is incident on the tapered regions and continues propagating in this same mode when it exits the tapered region and enters the next portion of the waveguide. That is, the light experiences a gradual transition between the tapered region 105 and the adjacent regions of the waveguide structure such that the mode of the light does not change and no significant loss of light takes place. The provision of such modal control of the light beam is very beneficial in the design of an athermal waveguide structure because it provides more flexibility, lower losses, better control, and an ability to athermalize the device over a larger temperature range in the presence of refractive index nonlinearities that may arise in the filler material 104.

In contrast to the adiabatic tapered waveguide used in the aforementioned embodiment, conventional arrangements that compensate for the temperature dependence of the refractive index of waveguide structures typically use a filler material having an opposite temperature dependence to that of the remainder of the waveguide. In these cases the filler material causes un-guided propagation of the beam as it enters the taper. In addition, light is lost at the abrupt interface that is formed between the filler material and the adjacent portions of the waveguide, which are formed from a different material.

It should be noted that equation 4 is not a necessary condition for athermalization. A breakdown of this condition will simply shift the center wavelength of a filter, without affecting its thermal sensitivity. This shift can be taken into account in the original filter design approach. Alternatively, an appropriate trimming method may be applied to bring back the center wavelength, e.g. using UV light or thermal annealing. Also, it may be preferable to have filler material with its refractive index lower than that of a core material across an entire operating temperature range, in order to preserve guiding properties of the waveguides.

Several material groups could be used as filler materials, e.g. deuterated polysiloxane, UV cured epoxy resin, fluorinated polymers, etc. It may be desired to match the filler's refractive index closely to the refractive index of the upper cladding. Commercial polymers in this category are now available from such companies as Zen Photonics, Optical Polymer Research, and RPO optical polymer waveguides. For instance fluoracrylate polymers from Zen Photonics have already been demonstrated to achieve acceptable optical performance in D. Kim, Y. Han, J. Shin, S. Park, H. Sung, S. Lee, Y. Lee, and D. Kim OFC 2003 Proceedings, v. 61, p. 61 (2003).

Although this invention has been described in terms of circuits made from silica-based planar waveguides, the invention also encompasses planar waveguide formed from other materials such as nonsilicate glasses, amorphous materials, organic and inorganic semiconductors.

### Example 1

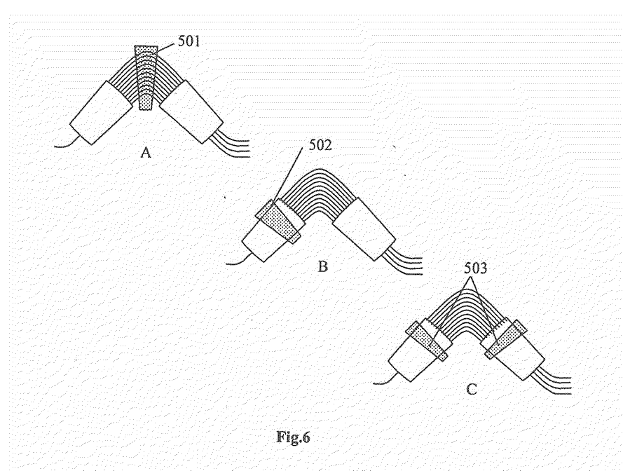

FIGS. 6(A)-6(C) each show an examples of arrayed waveguide gratings (AWG) with composite waveguides (top views) in accordance with the present invention. The AWG includes first and second free propagating optical coupling regions that are coupled by an arrayed waveguide region that includes a plurality of optical paths optically coupling the first coupling region to the second coupling region. This AWG could serve as an athermal wavelength multiplexing or de-multiplexing filter. The inventive athermalization method could be applied to any AWG design. The shape and size of the tapered region should be matched to the shape and size of a particular AWG, e.g. ΔL″ should be matched to the FSR of a given grating according to equations 4 and 5. FIG. 6A shows a tapered section 501 in the arrayed waveguide region of the AWG. In this instance the length of the composite section in each of the grating waveguide is given by

ΔL″ᵢ=ΔL*i (6)

FIG. 6B shows a tapered section 502 located in one of the free propagation coupling regions. FIG. 6C shows tapered sections 503 in both free propagation coupling regions.

### Example 2

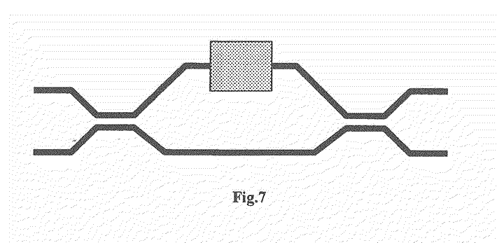

FIG. 7 shows a single stage Mach-Zehnder interferometer (MZI) filter made athermal using the composite waveguide approach of the present invention. As shown, the tapered section is positioned in the longer arm of the MZI. It length is chosen to satisfy equation 5, where L is given by the MZI arm length difference. More complex multistage filters using multiple MZIs can be made athermal using the same approach.

### Example 3

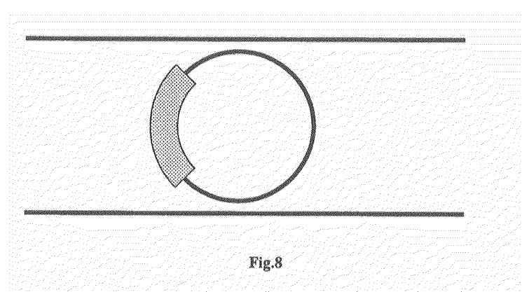

FIG. 8 shows an etalon filter based on a ring resonator circuit that is athermalized in accordance with the present invention. In this case L is the length of the ring resonator. More complex filters with multiple rings can be made athermal using the same approach. Furthermore, all pass filters with tunable or fixed chromatic dispersion compensation can be made athermal using the same approach.

### Example 4

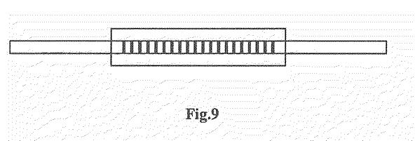

FIG. 9 shows a waveguide Bragg grating that is made athermal using a composite waveguide approach. In this case there may be an additional restriction on the length ΔL″ and index N″ that can be used with the Bragg grating, since this type of filter is not characterized by any specific FSR. Therefore, a set of solutions for equations 4 and 5 is reduced to just one, previously specified where dN″/dT=0. Similarly, appodized and chirped waveguide gratings can be made athermal using the same method.

1. A planar waveguide circuit comprising:
a silica-based planar optical waveguide circuit having a lower cladding, a core and an upper cladding;
at least one input waveguide and one output waveguide each coupled to the optical waveguide circuit;
at least one adiabatic tapered waveguide section located in the waveguide circuit and having an upper cladding segment that tapers down to at least the core to define a tapered recess; and
a filler material having a negative thermo-optic coefficient filling the tapered recess whereby said optical waveguide circuit has an optical characteristic with a reduced temperature dependence.

2. The planar waveguide circuit of claim 1 wherein said waveguide circuit comprises an optical filter and said optical characteristic is a transmission spectrum.

3. The planar waveguide circuit of claim 1 wherein the filler material is a polymer.

4. The planar waveguide circuit of claim 1 wherein said waveguide circuit comprises a Mach-Zehnder interferometer and said optical characteristic is a transmission spectrum.

5. The planar waveguide circuit of claim 1 wherein said waveguide circuit comprises a ring resonator filter and said optical characteristic is a transmission spectrum.

6. The planar waveguide circuit of claim 1 wherein said waveguide circuit comprises a ring resonator all pass filter and said optical characteristic is a dispersion spectrum.

7. The planar waveguide circuit of claim 1 wherein said waveguide circuit comprises a Bragg grating filter and said optical characteristic is a reflectance spectrum.

8. The planar waveguide circuit of claim 1 wherein said waveguide circuit comprises an arrayed waveguide grating having first and second free propagating optical coupling regions and an arrayed waveguide region that includes a plurality of optical waveguides optically coupling the first coupling region to the second coupling region, said optical characteristic being a transmission spectrum.

9. The planar waveguide circuit of claim 8 wherein said adiabatic tapered waveguide section is located in at least one of the free propagating waveguide sections.

10. The planar waveguide circuit of claim 8 wherein said adiabatic tapered waveguide section is located in said arrayed waveguide region.

11. A method comprising the steps of:
providing a silica-based planar optical waveguide circuit having a lower cladding, a core and an upper cladding;
providing at least one input waveguide and one output waveguide each coupled to the waveguide circuit;
providing at least one adiabatic tapered waveguide section located in the waveguide circuit and having an upper cladding that tapers down to a least the core to define a tapered recess; and
filling the tapered recess with a filler material having a negative thermo-optic coefficient so that said waveguide circuit has a transmission spectrum with a reduced temperature dependence.

12. The method of claim 11 wherein said waveguide circuit comprises an optical filter and said optical characteristic is a transmission spectrum.

13. The method of claim 11 wherein the filler material is a polymer.

14. The method of claim 11 wherein said waveguide circuit comprises a Mach-Zehnder interferometer and said optical characteristic is a transmission spectrum.

15. The method of claim 11 wherein said waveguide circuit comprises a ring resonator filter and said optical characteristic is a transmission spectrum.

16. The method of claim 11 wherein said waveguide circuit comprises a ring resonator all pass filter and said optical characteristic is a dispersion spectrum.

17. The method of claim 11 wherein said waveguide circuit comprises a Bragg grating filter and said optical characteristic is a reflectance spectrum.

18. The method of claim 11 wherein said waveguide circuit comprises an arrayed waveguide grating having first and second free propagating optical coupling regions and an arrayed waveguide region that includes a plurality of optical waveguides optically coupling the first coupling region to the second coupling region, said optical characteristic being a transmission spectrum.

19. The method of claim 18 wherein said adiabatic tapered waveguide section is located in at least one of the free propagating waveguide sections.

20. The method of claim 18 wherein said adiabatic tapered waveguide section is located in said arrayed waveguide region.
